(19) United States
(12) Patent Application Publication
(10) Pub. No.: US 2025/0100484 A1
(43) Pub. Date: Mar. 27, 2025

(54) ROUTING STRUCTURE

(71) Applicant: YAZAKI CORPORATION, Tokyo (JP)

(72) Inventors: Kosuke Tomosada, Makinohara-shi (JP); Naoto Kogure, Makinohara-shi (JP)

(21) Appl. No.: 18/892,320

(22) Filed: Sep. 20, 2024

(30) Foreign Application Priority Data
Sep. 26, 2023 (JP) 2023-163174

(51) Int. Cl. B60R 16/027; B60J 7/02; B60R 16/02

(52) U.S. Cl. CPC B60R 16/027; B60J 7/02; B60R 16/0215

(57) ABSTRACT

A routing structure includes: a first fixed portion that is fixed to a vehicle body of a vehicle; a second fixed portion that is fixed to a sliding body that moves in a vehicle front-rear direction with respect to an opening provided in a roof of the vehicle body; an exterior member that has a first end portion held by the first fixed portion and a second end portion held by the second fixed portion; an electric wire; and a biasing member, in which the sliding body moves in a vehicle up-down direction in addition to the vehicle front-rear direction between a fully closed position and a fully open position, and the exterior member is configured to be deformed while following a change in radius of the curved portion caused by the movement of the sliding body in the vehicle up-down direction.

### CROSS-REFERENCE TO RELATED APPLICATION(S)

The present application claims priority to and incorporates by reference the entire contents of Japanese Patent Application No. 2023-163174 filed in Japan on Sep. 26, 2023.

### BACKGROUND OF THE INVENTION

### 1. Field of the Invention

The present invention relates to a routing structure.

### 2. Description of the Related Art

Hitherto, there has been a routing structure between a fixed structure and a movable structure. Japanese Patent Application Laid-open No. 2010-195189 discloses a wire harness routing structure including an electric wire having one end electrically connected to an electrical component on a fixed structure and the other end electrically connected to an electrical component on a movable structure, a metal belt-shaped leaf spring having one end fixed to the fixed structure and the other end fixed to a movable-side structure, and a binding tool for binding the electric wire to the belt-shaped leaf spring.

It is preferable that an exterior member can be appropriately deformed when an electric wire is inserted into the exterior member and one end of the exterior member moves together with the sliding body. For example, when the sliding body moves not only in a sliding direction but also in a direction intersecting the sliding direction, a radius of a curved portion formed in the exterior member changes. When the exterior member cannot be appropriately deformed according to the change in radius of the curved portion, there is a possibility that the exterior member hinders the movement of the sliding body.

### SUMMARY OF THE INVENTION

An object of the present invention is to provide a routing structure capable of smoothly moving a sliding body.

In order to achieve the above mentioned object, a routing structure according to one aspect of the present invention includes a first fixed portion that is fixed to a vehicle body of a vehicle; a second fixed portion that is fixed to a sliding body that moves in a vehicle front-rear direction with respect to an opening provided in a roof of the vehicle body; an exterior member that has a first end portion held by the first fixed portion and a second end portion held by the second fixed portion; an electric wire that is inserted into the exterior member; and a biasing member that is inserted into the exterior member and forms a curved portion curved in the vehicle front-rear direction between the first end portion and the second end portion of the exterior member, wherein the sliding body moves in a vehicle up-down direction in addition to the vehicle front-rear direction between a fully closed position where the opening is closed and a fully open position where the opening is opened, and the exterior member is configured to be deformed while following a change in radius of the curved portion caused by the movement of the sliding body in the vehicle up-down direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a side view of a routing structure according to an embodiment;

FIG. 2 is a side view of the routing structure according to the embodiment;

FIG. 3 is a cross-sectional view of the routing structure according to the embodiment;

FIG. 4 is a side view of the routing structure according to the embodiment;

FIG. 5 is a view for describing deformation of an exterior member according to the embodiment;

FIG. 6 is a cross-sectional view of the routing structure according to the embodiment;

FIG. 7 is a cross-sectional view of the routing structure according to the embodiment;

FIG. 8 is a view for describing deformation of the exterior member according to the embodiment;

FIG. 9 is a cross-sectional view of a first fixed portion according to the embodiment;

FIG. 10 is a cross-sectional view of the routing structure according to the embodiment; and

FIG. 11 is a view for describing deformation of the exterior member according to the embodiment.

### DETAILED DESCRIPTION OF THE PREFERRED EMBODIMENTS

Hereinafter, a routing structure according to an embodiment of the present invention will be described in detail with reference to the drawings. Note that the present invention is not limited by the embodiment. In addition, constituent elements in the following embodiment include those that can be easily assumed by those skilled in the art or those that are substantially the same.

### Embodiment

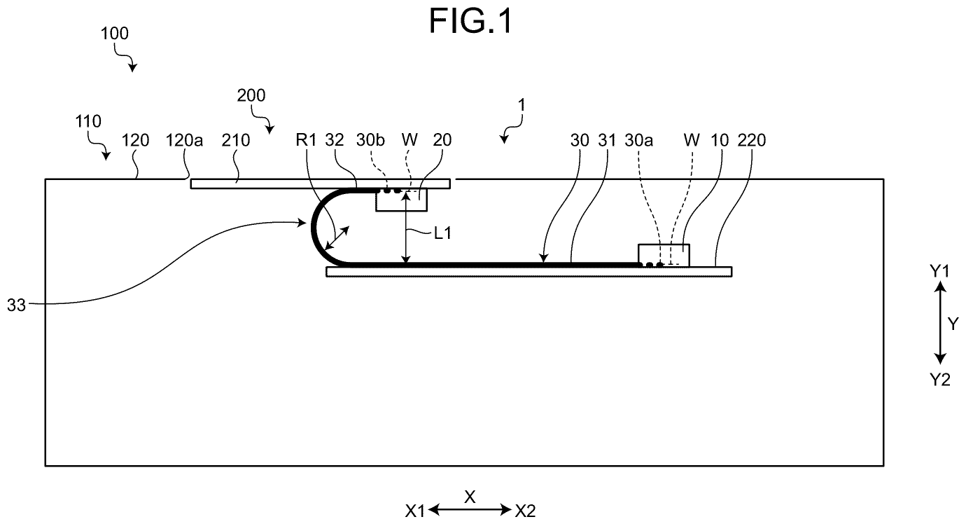

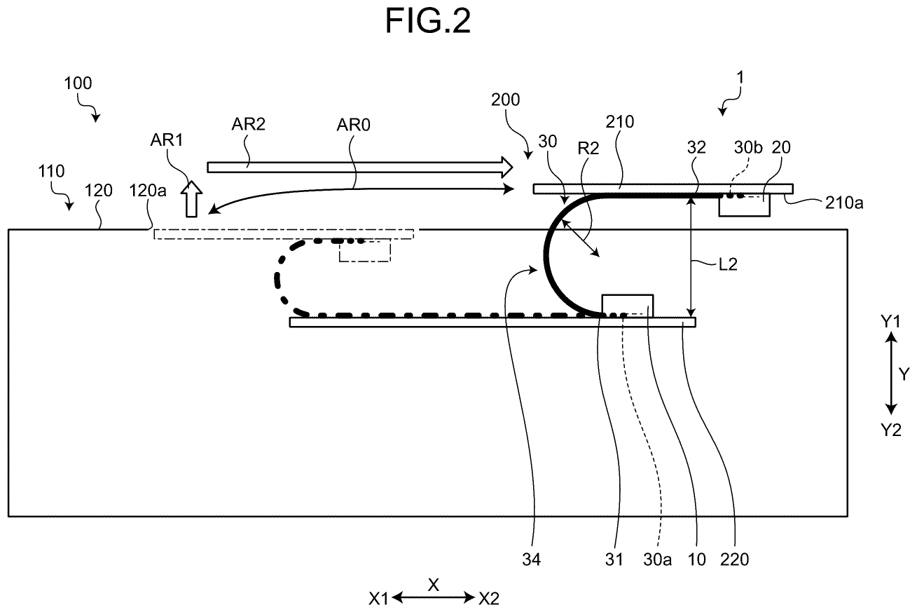

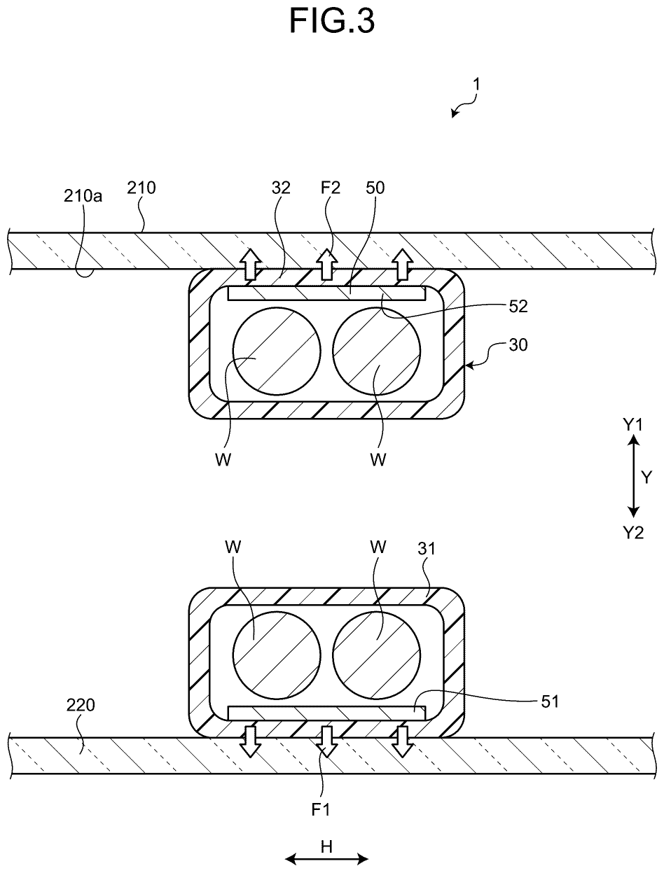

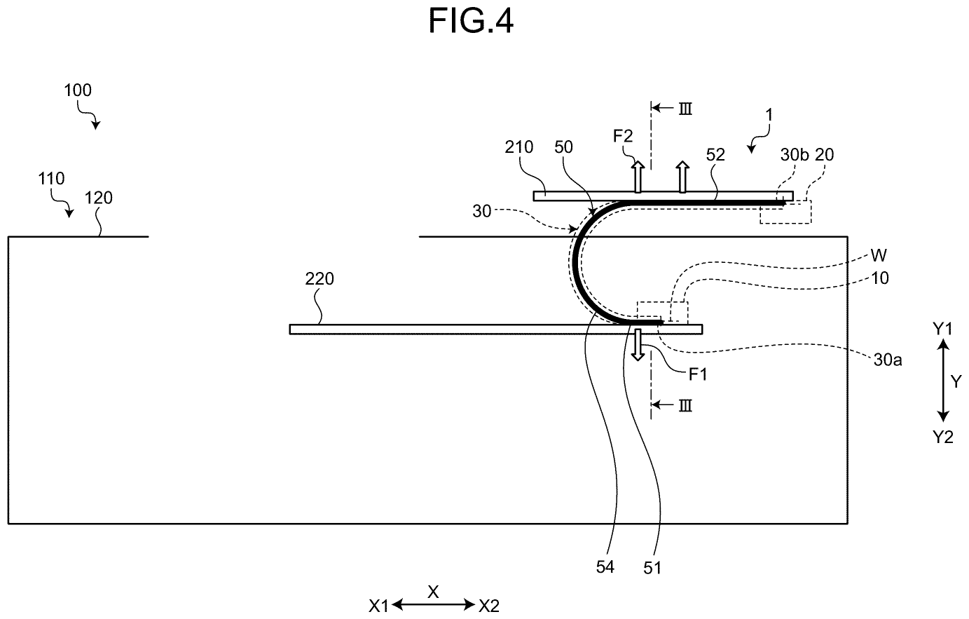

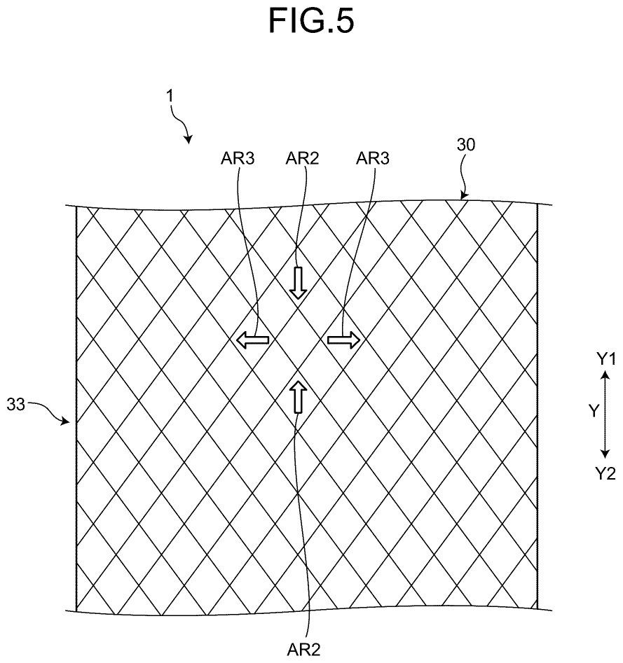

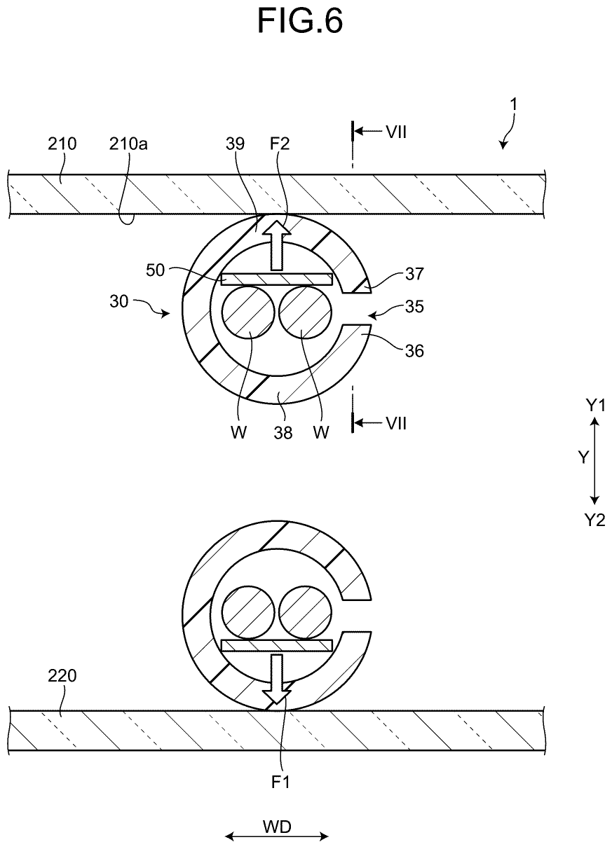

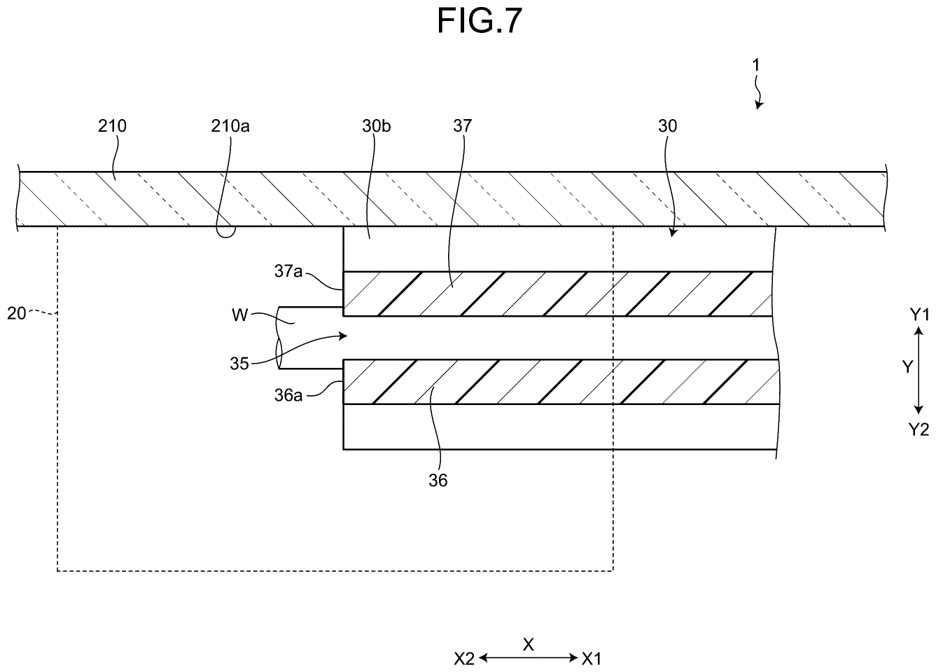

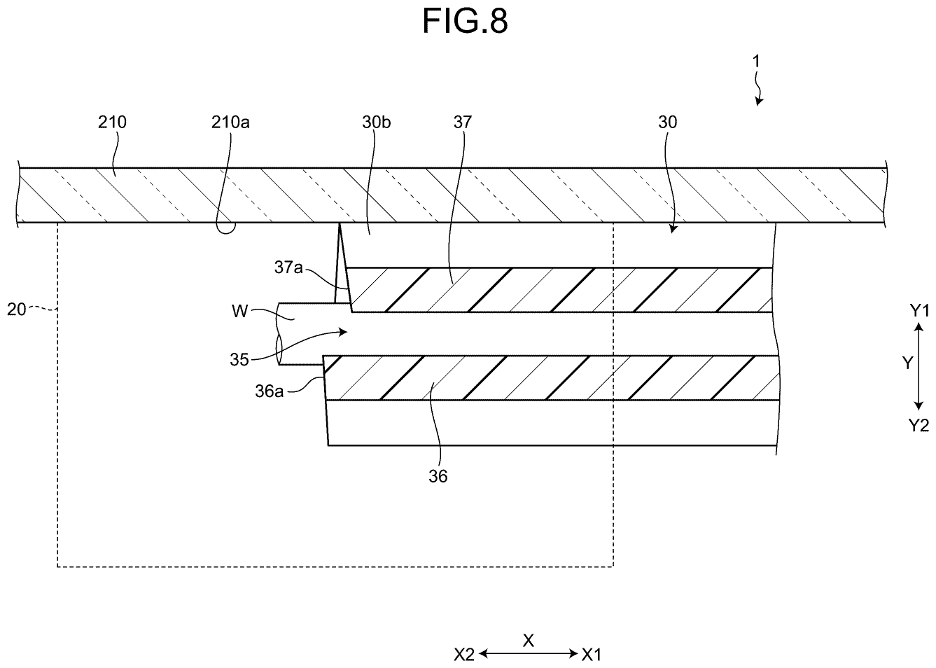

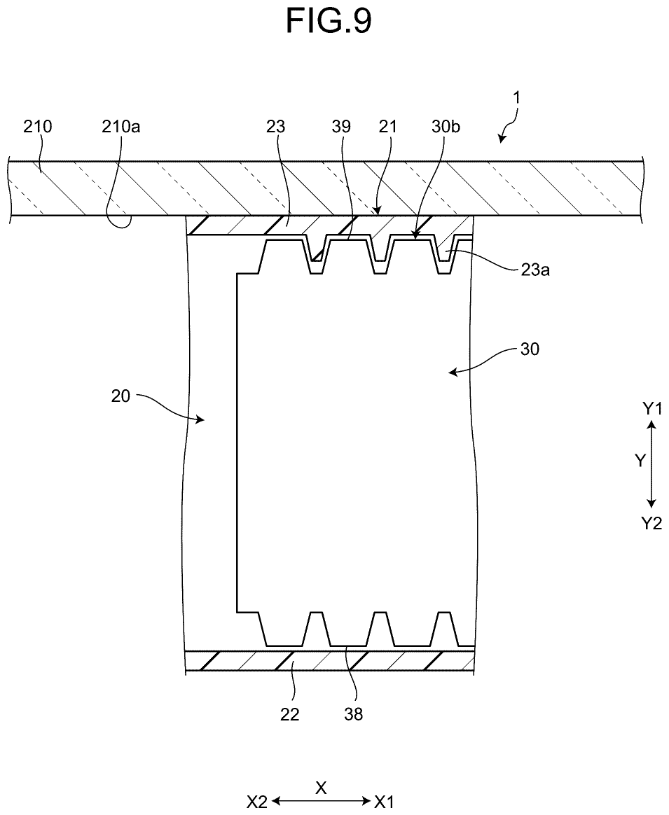

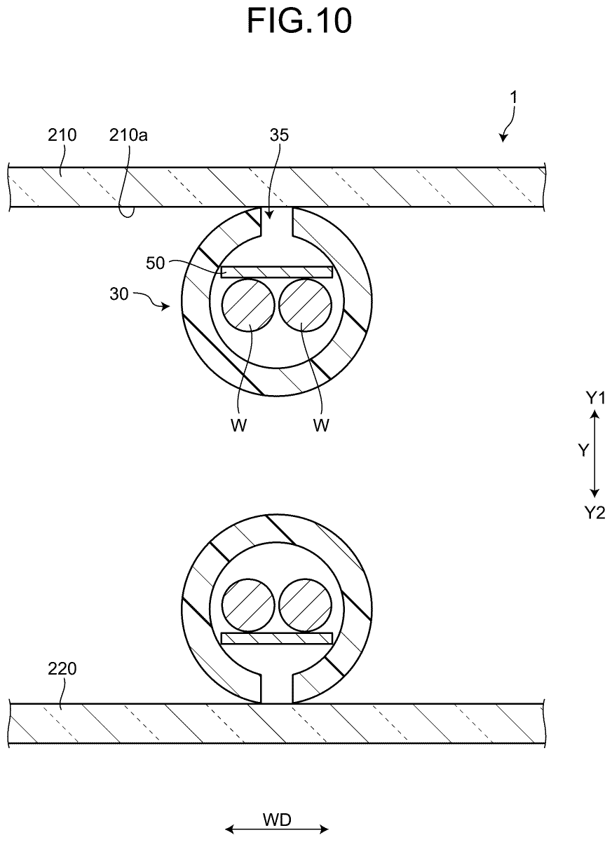

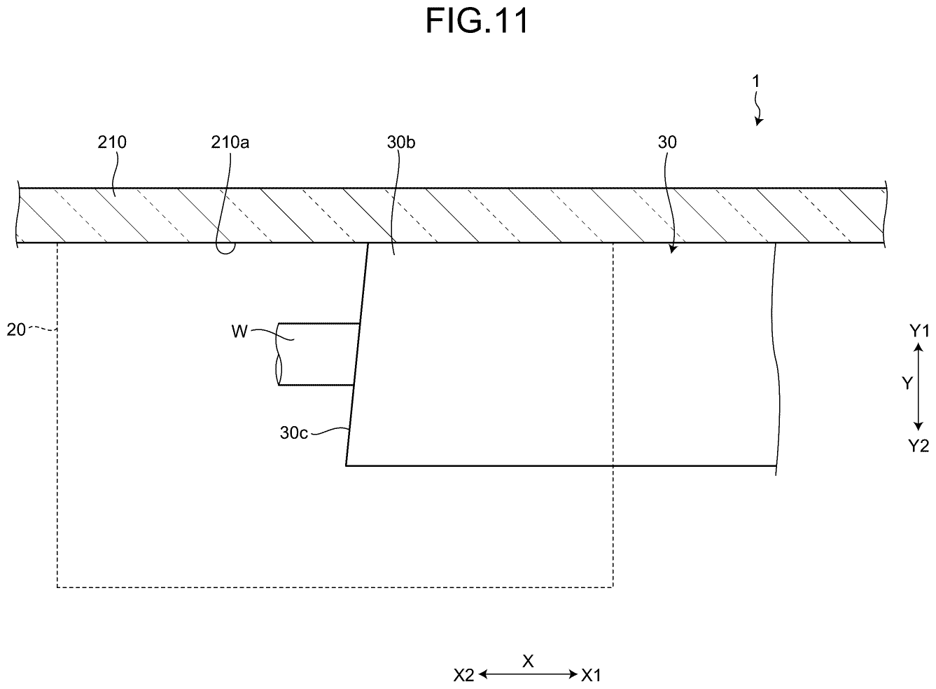

An embodiment will be described with reference to FIGS. 1 to 11. The present embodiment relates to a routing structure. FIGS. 1 and 2 are side views of the routing structure according to the embodiment, FIG. 3 is a cross-sectional view of the routing structure according to the embodiment, FIG. 4 is a side view of the routing structure according to the embodiment, FIG. 5 is a view for describing deformation of an exterior member according to the embodiment, FIGS. 6 and 7 are cross-sectional views of the routing structure according to the embodiment, FIG. 8 is a view for describing deformation of the exterior member according to the embodiment, FIG. 9 is a cross-sectional view of a first fixed portion according to the embodiment, FIG. 10 is a cross-sectional view of the routing structure according to the embodiment, and FIG. 11 is a view for describing deformation of the exterior member according to the embodiment. FIG. 3 illustrates a cross section taken along line III-III of FIG. 4. FIG. 7 illustrates a cross section taken along line VII-VII of FIG. 6.

As illustrated in FIG. 1, a routing structure 1 of the embodiment is applied to a sunroof 200 of a vehicle 100. The vehicle 100 is, for example, an automobile on which a power source such as a motor or an engine is mounted. The vehicle 100 includes a vehicle body 110. The vehicle body 110 includes a roof 120 that covers a vehicle interior. The roof 120 has an opening 120a that is opened upward.

The vehicle 100 includes a sunroof 200 that opens and closes the opening 120a. The sunroof 200 includes a sliding body 210, a rail 220, and the routing structure 1. The sliding body 210 is a member that slides in a vehicle front-rear direction X with respect to the opening 120a. The sliding body 210 of the present embodiment is a plate-shaped member that closes the opening 120a or opens the opening 120a. The sliding body 210 may be glass that can transmit light.

The sunroof 200 includes a mechanism such as a link mechanism that moves the sliding body 210 along a predetermined path, and a drive source such as a motor that operates the mechanism. The sunroof 200 moves the sliding body 210 between a fully closed position where the opening 120a is closed and a fully open position where the opening 120a is opened. FIG. 1 illustrates the sliding body 210 at the fully closed position. FIG. 2 illustrates the sliding body 210 at the fully open position.

The rail 220 is fixed to the vehicle body 110. The rail 220 extends in the vehicle front-rear direction X. The rail 220 supports the mechanism that moves the sliding body 210, and guides the mechanism in the vehicle front-rear direction X. The rail 220 further supports an exterior member 30 to form a first extending portion 31 in the exterior member 30.

The sunroof 200 of the present embodiment moves the sliding body 210 along a path AR0 illustrated in FIG. 2. The movement of the sliding body 210 along the path AR0 includes movement in the vehicle front-rear direction X and movement in a vehicle up-down direction Y. When the sliding body 210 moves from the fully closed position to the fully open position, the sliding body 210 moves toward an upper side Y1 in the vehicle up-down direction Y as indicated by an arrow AR1 in FIG. 2 and moves toward a rear side X2 in the vehicle front-rear direction X.

Conversely, when the sliding body 210 moves from the fully open position to the fully closed position, the sliding body 210 moves toward a front side X1 in the vehicle front-rear direction X and moves toward a lower side Y2 in the vehicle up-down direction Y.

As illustrated in FIGS. 1 to 3, the routing structure 1 includes a first fixed portion 10, a second fixed portion 20, an exterior member 30, an electric wire W, and a biasing member 50. The exterior member 30 and the electric wire W form a wire harness routed between the vehicle body 110 and the sliding body 210.

The first fixed portion 10 is a member fixed to the vehicle body 110 of the vehicle 100. The first fixed portion 10 may be a protector that protects the electric wire W. The first fixed portion 10 is molded using, for example, an insulating synthetic resin. The first fixed portion 10 has a space in which the electric wire W is routed and includes a holding structure for holding the exterior member 30.

The second fixed portion 20 is a member fixed to the sliding body 210 of the sunroof 200. The second fixed portion 20 may be a protector that protects the electric wire W. The second fixed portion 20 is molded using, for example, an insulating synthetic resin. The second fixed portion 20 has a space in which the electric wire W is routed and includes a holding structure for holding the exterior member 30.

The exterior member 30 is an elastically deformable tubular member. The exterior member 30 is, for example, a braided tube. The braided tube is formed by braiding fibers in a mesh shape. The fibers forming the braided tube preferably have stretchability. As described below, the exterior member 30 is stretchable, and is configured to be deformed while following a change in radius of a curved portion.

The exterior member 30 has a first end portion 30a held by the first fixed portion 10 and a second end portion 30b held by the second fixed portion 20. The first fixed portion 10 holds the first end portion 30a such that the exterior member 30 extends from the first fixed portion 10 along the rail 220 in the vehicle front-rear direction X. The first fixed portion 10 of the present embodiment holds the first end portion 30a such that the exterior member 30 extends from the first fixed portion 10 toward the front side X1.

The second fixed portion 20 holds the second end portion 30b such that the exterior member 30 extends from the second fixed portion 20 along the sliding body 210 in the vehicle front-rear direction X. The second fixed portion 20 of the present embodiment holds the second end portion 30b such that the exterior member 30 extends from the second fixed portion 20 toward the front side X1.

The electric wire W and the biasing member 50 are inserted into the exterior member 30. The electric wire W is, for example, a sheathed electric wire including a stranded wire and a sheath. The electric wire W may be a flat routing member, a printed circuit body, or another circuit body. The electric wire W led out from the first end portion 30a is connected to a power supply or a control device arranged in the vehicle body 110. The electric wire W led out from the second end portion 30b is connected to a load arranged on the sliding body 210. The load arranged on the sliding body 210 may be, for example, a lighting device, a light control film arranged on the glass of the sliding body 210, or another electric load.

As illustrated in FIGS. 1 and 2, the exterior member 30 has curved portions 33 and 34 that are curved in the vehicle front-rear direction X between the first end portion 30a and the second end portion 30b. The curved portion 33 illustrated in FIG. 1 is a curved portion formed in the exterior member 30 in a state in which the sliding body 210 is at the fully closed position. The curved portion 33 has a radius R1. The curved portion 34 illustrated in FIG. 2 is a curved portion formed in the exterior member 30 in a state in which the sliding body 210 is at the fully open position. The curved portion 34 has a radius R2. The electric wire W in which the curved portions 33 and 34 are formed has a U shape or a J shape.

As illustrated in FIG. 1, when the sliding body 210 is at the fully closed position, a distance between the second end portion 30b and the first end portion 30a in the vehicle up-down direction Y is a first distance L1. The radius R1 of the curved portion 33 is half the first distance L1.

As illustrated in FIG. 2, when the sliding body 210 is at the fully open position, a distance between the second end portion 30b and the first end portion 30a in the vehicle up-down direction Y is a second distance L2. The radius R2 of the curved portion 34 is half the second distance L2.

The second end portion 30b of the exterior member 30 moves together with the sliding body 210. At this time, the exterior member 30 follows movement of the second fixed portion 20 while gradually changing a position where the curved shape is formed.

The biasing member 50 of the present embodiment has rigidity capable of pressing the exterior member 30 toward the sliding body 210. The biasing member 50 is a rod-shaped or plate-shaped member and is elastically deformable. The biasing member 50 is made of metal or resin.

As illustrated in FIG. 3, a cross-sectional shape of the biasing member 50 of the present embodiment is rectangular. The illustrated biasing member 50 has a flat plate shape, and is, for example, a metal plate or a resin plate. The exterior member 30 can be deformed into a shape corresponding to the shape of the biasing member 50. A cross-sectional shape of the exterior member 30 in a state in which the biasing member 50 and the electric wire W are housed therein is, for example, rectangular. The biasing member 50 faces each of the plurality of electric wires W in the vehicle up-down direction Y. In other words, the biasing member 50 has a width capable of supporting the plurality of electric wires W.

The biasing member 50 in FIG. 3 is arranged on an outer side of the electric wire W. Therefore, in the curved portions 33 and 34, the biasing member 50 is positioned on the outer side of the electric wire W in the radial direction. As illustrated in FIG. 3, the biasing member 50 comes into contact with the exterior member 30, and applies pressing forces F1 and F2 to the exterior member 30 at a contact surface.

As illustrated in FIG. 4, the exterior member 30, the electric wire W, and the biasing member 50 are routed in a state of being curved in a U shape or a J shape. That is, the biasing member 50 extends from the first fixed portion 10 to the second fixed portion 20 in a state of having a curved portion 54.

The biasing member 50 bent so as to have the curved portion 54 applies the pressing force F1 and the pressing force F2 to the exterior member 30. The pressing force F1 is a force in the vehicle up-down direction Y, and presses the exterior member 30 toward the rail 220. The pressing force F2 is a force in the vehicle up-down direction Y, and presses the exterior member 30 toward the sliding body 210. The pressing forces F1 and F2 are restoring forces generated in the bent biasing member 50.

The pressing force F1 forms the first extending portion 31 in the exterior member 30. As illustrated in FIG. 1, the first extending portion 31 is a portion extending along the rail 220. The pressing force F2 forms a second extending portion 32 in the exterior member 30. As illustrated in FIG. 2 and the like, the second extending portion 32 is a portion extending along a vehicle interior side surface 210a of the sliding body 210. The vehicle interior side surface 210a is a surface facing the lower side Y2. In a case where the vehicle interior side surface 210a is a flat surface, the second extending portion 32 is formed linearly. In a case where the vehicle interior side surface 210a has a curved shape, the second extending portion 32 has a curved shape along the vehicle interior side surface 210a.

The biasing member 50 of the present embodiment is configured to press the exterior member 30 toward the sliding body 210 when the sliding body 210 is at the fully closed position and when the sliding body 210 is at the fully open position. In other words, the biasing member 50 has rigidity that can constantly press the exterior member 30 toward the sliding body 210 and bring the exterior member 30 into contact with the sliding body 210. Therefore, the routing structure 1 of the present embodiment can stabilize the shape of the exterior member 30. The biasing member 50 can bring the exterior member 30 into contact with the sliding body 210 against an external force such as vibration generated during traveling, for example.

Here, the sunroof 200 of the present embodiment is configured to move the sliding body 210 in the vehicle up-down direction Y at the time of opening and closing. As the sliding body 210 moves in the vehicle up-down direction Y, a value of the radius R2 of the curved portion 34 at the fully open position is different from a value of the radius R1 of the curved portion 33 at the fully closed position. It is preferable that, in a case where the radii of the curved portions 33 and 34 change as described above, the exterior member 30 can flexibly follow the change in radius.

For example, when the sliding body 210 moves from the fully open position to the fully closed position, the radius of the curved portion decreases from the radius R2 in FIG. 2 to the radius R1 in FIG. 1. In this case, an inner circumferential portion of the curved portion is compressed in a circumferential direction.

Since the braided tube is used as the exterior member 30, the inner circumferential portion of the curved portion can be deformed according to the compression in the circumferential direction. FIG. 5 illustrates an inner circumferential surface of the curved portion 33 in the exterior member 30. In other words, FIG. 5 is a view of the curved portion 33 in FIG. 1 when viewed from the rear side X2. In a case where the radius of the curved portion decreases, the inner circumferential surface of the exterior member 30 is compressed in the circumferential direction and deformed so as to extend in the width direction. As indicated by an arrow AR2, each mesh of the exterior member 30 contracts in the circumferential direction. As indicated by an arrow AR3, each mesh of the exterior member 30 stretches in the width direction.

When the radius of the curved portion decreases, an outer circumferential surface of the curved portion 33 is deformed so as to stretch in the circumferential direction and contract in the width direction. That is, the exterior member 30 can offset the stretching of the inner circumferential surface in the width direction with the contraction of the outer circumferential surface in the width direction. Therefore, the exterior member 30 can follow the decrease of the radius of the curved portion.

As a comparative example, in a case of an exterior member that cannot be deformed according to the decrease of the radius, wrinkles may be formed on the exterior member. The wrinkle formed on the exterior member causes a resistance force against the movement of the sliding body 210. As a result, an increase in size of the motor and an increase in size of the biasing member 50 are caused. On the other hand, the exterior member 30 of the present embodiment can be flexibly deformed according to the decrease of the radius. Therefore, the exterior member 30 of the present embodiment can achieve size reduction of the sunroof 200.

In a case where the radius of the curved portion increases, the exterior member 30 is deformed in an opposite way to that when the radius decreases. In the exterior member 30, the inner circumferential surface of the curved portion stretches in the circumferential direction, and the outer circumferential surface contracts in the circumferential direction. Therefore, the inner circumferential surface and the outer circumferential surface of the exterior member 30 are deformed in opposite directions to each other, so that the exterior member can follow the increase of the radius of the curved portion. As described above, the exterior member 30 of the present embodiment is configured to be deformed while following the change in radius of the curved portion caused by the movement of the sliding body 210.

The exterior member 30 may be a flexible tube such as a corrugated tube. FIG. 6 illustrates a corrugated tube as the exterior member 30. The exterior member 30 is a tubular member and has flexibility. The exterior member 30 has a slit 35. The slit 35 is provided over the entire length from the first end portion 30a to the second end portion 30b of the exterior member 30. That is, the exterior member 30 has a C-shaped cross section.

The exterior member 30 in FIG. 6 has a first edge portion 36 and a second edge portion 37 facing each other with the slit 35 interposed therebetween. The first edge portion 36 and the second edge portion 37 are end portions along the slit 35, and extend in an axial direction of the exterior member 30. The first edge portion 36 is positioned on an inner side with respect to the second edge portion 37 in the radial direction at the curved portions 33 and 34.

The exterior member 30 has a first semi-cylindrical portion 38 including the first edge portion 36 and a second semi-cylindrical portion 39 including the second edge portion 37. The semi-cylindrical portions 38 and 39 have a semicircular cross-sectional shape. The first semi-cylindrical portion 38 is positioned on an inner circumferential side at the curved portions 33 and 34. The second semi-cylindrical portion 39 is a portion positioned on an outer circumferential side at the curved portions 33 and 34, and is in contact with the sliding body 210 and the rail 220. Since the exterior member 30 in FIG. 6 has the slit 35, the exterior member 30 can be deformed while following the change in radius of the curved portion.

The exterior member 30 in FIG. 6 is arranged with the slit 35 oriented in a vehicle width direction WD. In this case, the slit 35 is oriented in a direction orthogonal to the vehicle up-down direction Y in a cross section orthogonal to the vehicle front-rear direction X. As described below, the exterior member 30 can follow the change in radius of the curved portion by being deformed such that the first edge portion 36 is shifted with respect to the second edge portion 37.

FIG. 7 illustrates a cross section of the first end portion 30a when the sliding body 210 is at the fully open position. In this case, as illustrated in FIG. 2, the curved portion 34 having a relatively large diameter is formed in the exterior member 30. As illustrated in FIG. 7, in the first end portion 30a, an end surface 36a of the first edge portion 36 and an end surface 37a of the second edge portion 37 are at the same position in the vehicle front-rear direction X.

FIG. 8 illustrates a cross section of the first end portion 30a when the sliding body 210 is at the fully closed position. In this case, as illustrated in FIG. 1, the curved portion 33 having a relatively small diameter is formed in the exterior member 30. As illustrated in FIG. 8, the exterior member 30 is deformed such that the first edge portion 36 is shifted with respect to the second edge portion 37 in an extending direction of the slit 35. More specifically, the exterior member 30 is deformed such that the first edge portion 36 is relatively shifted toward the rear side X2 with respect to the second edge portion 37. In the deformed exterior member 30, the end surface 36a of the first edge portion 36 is shifted toward the rear side X2 with respect to the end surface 37a of the second edge portion 37. By such deformation, the exterior member 30 follows the decrease of the radius of the curved portion while reducing the degree of compression on the inner circumferential side of the curved portion 33.

When the sliding body 210 moves from the fully closed position to the fully open position, the exterior member 30 is deformed such that the first edge portion 36 is relatively shifted toward the front side X1 with respect to the second edge portion 37. The exterior member 30 follows the increase of the radius of the curved portion by such deformation. As described above, the corrugated tube as the exterior member 30 is configured to be deformed while following the change in radius of the curved portion caused by the movement of the sliding body 210.

As described with reference to FIG. 9, the second fixed portion 20 allows the exterior member 30 to be deformed such that the first edge portion 36 is shifted with respect to the second edge portion 37. As illustrated in FIG. 9, the second fixed portion 20 includes a holding structure 21 that holds the second end portion 30b of the exterior member 30. The holding structure 21 includes a first holding portion 22 and a second holding portion 23. The first holding portion 22 holds the first semi-cylindrical portion 38 of the exterior member 30.

The second holding portion 23 holds the second semi-cylindrical portion 39 of the exterior member 30. The second holding portion 23 has a protrusion 23a. The protrusion 23a is engaged with a groove of the corrugated tube as the exterior member 30 to lock the second semi-cylindrical portion 39. The second holding portion 23 restricts movement of the second semi-cylindrical portion 39 in the vehicle front-rear direction X.

The first holding portion 22 allows the first semi-cylindrical portion 38 to move in the vehicle front-rear direction X. A holding surface of the first holding portion 22 allows the first semi-cylindrical portion 38 to slide in the vehicle front-rear direction X. The holding surface of the first holding portion 22 is, for example, a smooth surface having no unevenness. Therefore, the second fixed portion 20 allows the exterior member 30 to be deformed as illustrated in FIG. 8.

The holding structure 21 may be configured to restrict the movement of the first semi-cylindrical portion 38 and allow the sliding of the second semi-cylindrical portion 39 in the vehicle front-rear direction X. Also with such a configuration, it is possible to allow the exterior member 30 to be deformed as illustrated in FIG. 8.

In the exterior member 30 of the present embodiment, the first end portion 30a can also be deformed similarly to the second end portion 30b. When the radius of the curved portion changes, the exterior member 30 is deformed such that the first edge portion 36 is shifted with respect to the second edge portion 37 at the first end portion 30a. The first fixed portion 10 holds the first end portion 30a so as to allow such deformation of the exterior member 30.

The orientation of the slit 35 is not limited to the vehicle width direction WD illustrated in FIG. 6. FIG. 10 illustrates an example of arrangement of the exterior member 30. The exterior member 30 in FIG. 10 is arranged such that the slit 35 is oriented in the vehicle up-down direction Y. More specifically, the exterior member 30 is arranged such that the slit 35 is oriented outward in the radial direction at the curved portion. In this case, the slit 35 faces the sliding body 210 and the rail 220.

The exterior member 30 arranged as described above can be deformed while following the change in radius of the curved portion caused by the movement of the sliding body 210. FIG. 11 illustrates a shape of the second end portion 30b when the sliding body 210 is at the fully closed position. The exterior member 30 is deformed such that an end surface 30c of the second end portion 30b is inclined. The end surface 30c is inclined toward the rear side X2 as the distance from the sliding body 210 in the vehicle up-down direction Y increases. By such deformation, the exterior member 30 follows the decrease of the radius of the curved portion while reducing the degree of compression on the inner circumferential side of the curved portion 33. The exterior member 30 having the slit 35 has a higher degree of freedom of deformation than that in a case where the slit 35 is not provided. Therefore, the exterior member 30 can follow the change in radius of the curved portion by being deformed so as to change the degree of inclination of the end surface 30c.

In the exterior member 30 illustrated in FIG. 10, the first end portion 30a can also be deformed similarly to the second end portion 30b. That is, the exterior member 30 is deformable such that the end surface of the first end portion 30a is inclined similarly to the end surface of the second end portion 30b. The end surface of the first end portion 30a is inclined toward the rear side X2 as the distance from the rail 220 in the vehicle up-down direction Y increases.

The arrangement of the biasing member 50 inside the exterior member 30 is not limited to the arrangement in FIGS. 3, 6, and 10. For example, the biasing member 50 may be arranged so as to be positioned on the inner side of the electric wire W in the radial direction at the curved portions 33 and 34.

As described above, the routing structure 1 of the present embodiment includes the first fixed portion 10, the second fixed portion 20, the exterior member 30, the electric wire W, and the biasing member 50. The first fixed portion 10 is fixed to the vehicle body 110 of the vehicle 100. The second fixed portion 20 is fixed to the sliding body 210. The sliding body 210 slides in the vehicle front-rear direction X with respect to the opening 120a provided in the roof 120 of the vehicle body 110. The exterior member 30 has a first end portion 30a held by the first fixed portion 10 and a second end portion 30b held by the second fixed portion 20. The electric wire W and the biasing member 50 are inserted into the exterior member 30.

The biasing member 50 forms the curved portions 33 and 34 curved in the vehicle front-rear direction X between the first end portion 30a and the second end portion 30b of the exterior member 30. The sliding body 210 moves in the vehicle up-down direction Y in addition to the vehicle front-rear direction X between the fully closed position where the opening 120a is closed and the fully open position where the opening 120a is opened. The exterior member 30 is configured to be deformed while following the change in radius of the curved portion caused by the movement of the sliding body 210 in the vehicle up-down direction Y. In the routing structure 1 of the present embodiment, the exterior member 30 is deformed while following the change in radius of the curved portion, so that the sliding body 210 can be smoothly moved.

The exterior member 30 is, for example, a braided tube that stretches and contracts following the change in radius of the curved portion. The braided tube can follow the change in radius by being stretched and contracting in the circumferential direction of the curved portion and the width direction.

The exterior member 30 is, for example, a flexible tube, and has the slit 35 extending over the entire length from the first end portion 30a to the second end portion 30b. The tube having the slit 35 over its entire length has a high degree of freedom of deformation and can be deformed following the change in radius of the curved portion.

The flexible tube can have the first edge portion 36 and the second edge portion 37 facing each other with the slit 35 interposed therebetween. The flexible tube can follow the change in radius of the curved portion by being deformed such that the first edge portion 36 is shifted with respect to the second edge portion 37 in the extending direction of the slit 35.

The flexible tube is arranged, for example, with the slit 35 oriented in the vehicle width direction WD. Such an arrangement is suitable for such deformation that the first edge portion 36 is shifted with respect to the second edge portion 37.

The contents disclosed in the above embodiment can be appropriately combined and executed.

The routing structure according to the present embodiment includes the exterior member and the biasing member that is inserted into the exterior member and forms a curved portion curved in a vehicle front-rear direction between a first end portion and a second end portion of the exterior member. The exterior member is configured to be deformed while following the change in radius of the curved portion caused by movement of the sliding body in the vehicle up-down direction. With the routing structure of the present embodiment, it is possible to smoothly move the sliding body.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A routing structure comprising:
a first fixed portion that is fixed to a vehicle body of a vehicle;
a second fixed portion that is fixed to a sliding body that moves in a vehicle front-rear direction with respect to an opening provided in a roof of the vehicle body;
an exterior member that has a first end portion held by the first fixed portion and a second end portion held by the second fixed portion;
an electric wire that is inserted into the exterior member; and
a biasing member that is inserted into the exterior member and forms a curved portion curved in the vehicle front-rear direction between the first end portion and the second end portion of the exterior member, wherein
the sliding body moves in a vehicle up-down direction in addition to the vehicle front-rear direction between a fully closed position where the opening is closed and a fully open position where the opening is opened, and
the exterior member is configured to be deformed while following a change in radius of the curved portion caused by the movement of the sliding body in the vehicle up-down direction.

2. The routing structure according to claim 1, wherein
the exterior member is a braided tube that stretches and contracts following the change in radius of the curved portion.

3. The routing structure according to claim 1, wherein
the exterior member is a flexible tube and has a slit extending over an entire length from the first end portion to the second end portion.

4. The routing structure according to claim 3, wherein
the exterior member has a first edge portion and a second edge portion facing each other with the slit interposed therebetween, and
the exterior member is deformed such that the first edge portion is shifted with respect to the second edge portion in an extending direction of the slit to follow the change in radius of the curved portion.

5. The routing structure according to claim 4, wherein
the exterior member is arranged with the slit oriented in a vehicle width direction.
